(19) United States
(12) Patent Application Publication
(10) Pub. No.: US 2010/0037145 A1
(43) Pub. Date: Feb. 11, 2010

(54) METHOD AND SYSTEM FOR A PERSONALIZED WEB PAGE

(75) Inventor: Eran Sides, Tel-Aviv (IL)

Correspondence Address: The Law Office of Michael E. Kondoudis, 888 16th Street, N.W., Suite 800, Washington, DC, 20006, US

(73) Assignee: Alefo Interactive Ltd., Tel-Aviv (IL)

(21) Appl. No.: 12/482,756

(22) Filed: Jun. 11, 2009

Related U.S. Application Data
(63) Continuation-in-part of application No. 11/292,864, filed on Dec. 1, 2005, now abandoned.

(51) Int. Cl. G06F 3/00

(52) U.S. Cl. 715/744

(57) ABSTRACT

A method and apparatus for constructing and using a personalized web page, the personalized web page comprising an at least one module which is a fragment of a second web page having a locator, the second web page stored on a web site, the fragment identified by at least two coordinates within the second web page. The method comprises the steps of selecting the fragment of the second web page, placing the module on the personalized web page; and storing a description of the personalized web page on a server, wherein the description comprises the locator and the coordinates of the fragment of the second web page within the second web page.

### CROSS REFERENCE TO RELATED APPLICATIONS

This application is a continuation in part, and claims the benefit of U.S. patent application Ser. No. 11/292,864 filed on Dec. 1, 2005, which is incorporated herein by reference. This application further claims the benefit of WIPO Publication No. WO2007063549, which is incorporated herein by reference.

### BACKGROUND

1. Technical Field

The present invention relates to the field of the Internet, and more particularly, to creating a personalized electronic document.

2. Discussion of Related Art

Internet users have different preferences for their home page, i.e., the first web page that loads when they start surfing the Internet. Many users use a portal as their home page. A portal is usually a home page belonging to a site, which contains various data items, such as texts, pictures and links to other pages within that site or at other sites. Some portals are freely accessible for anyone, while others are specific and only a group of users, for example the employees of a corporation, are allowed to access them. However, in all these cases, the user is limited to the contents and layout as chosen by the manager of the site, and the user can not freely choose contents from different sites that are of interest, and certainly not their layout. The user can not view simultaneously data from multiple web pages, for example the home page of his favorite sports team, and the news headlines from another site.

The user can only design a web page according to his/her preferences (hereinafter referred to as “personalized web page”), if the user has certain abilities such as programming abilities.

There is therefore a need for an apparatus and method that enables the user to easily construct a personalized web page that can serve his/her home page. The user should be able, without having to program or having the need use complex systems, to construct the personalized web page, which contains data from multiple sources, utilities, and other items, and to design the personalized web page in any desired layout.

### BRIEF SUMMARY

It is an object of the present invention to provide a novel method for detecting performance deficiencies of an operational environment, which overcomes the disadvantages known in the art.

In embodiments of the present invention, there is thus provided a user with method and system for constructing and using a web page (hereinafter referred to as “personalized web page”) according to said user's preferences. The personalized web page comprises one or more first modules, each first module being a fragment of a second web page having a locator and stored on a web site, the fragment identified by two or more coordinates within the second web page, each coordinate comprising two numbers, the method comprising the steps of selecting the fragment of the second web page; placing the first module on the personalized web page; and storing a description of the personalized web page on a storage device. Within the method, the description of the personalized web page includes the locator of the second web page and the coordinates of the fragment of the second web page, within the second web page. The locator can be a Unified Source Locator. The method can further comprise the steps of retrieving the description of the personalized web page from the storage device; loading the second web page; and clipping the second web page according to coordinates of the fragment of the second web page. Within the method, the second web page is loaded from the web site. Within the method, the personalized web page is a home page or a personalized portal. The first module can be collapsed, expanded, placed on an icon tray, or retrieved from the icon tray. The first module can be refreshed at predetermined intervals. Within the method, the personalized web page can comprise one or more second modules. The method can further comprise the step of presenting the second modules on the personalized web page. Each second module is a utility, which can be, for example, a clock; a world clock; a calendar; a holiday and special times utility; a chat tool; a radio-like or TV-like tool; a media guide; a bills payment service; a postal delivery service; a price comparing tool; a phone directory; a short messaging service (SMS) or multi-media messaging service (MMS) sending tool; a translator or a trans-literature tool; a downloading tool; an uploading tool, a weather reporting tool; a calculator of any type, including a scientific calculator, an economics calculator and others; an e-mail checking utility; a maps utility; a currency exchange and conversion rates tool; a memo pad; a search engine; a stock quote tool; a domain-specific utility, any combination thereof, and the like. Each second module can be a Rich Site Summary (RSS) feed. Each second module can be collapsed, expanded, placed on an icon tray, or retrieved from the icon tray. Each second module can be refreshed at predetermined intervals. Within the method, the personalized web page can be used as an active desktop. The personalized web page can be viewed from a platform, the platform can be a personal computer; a network computer; a laptop computer; a handheld device; or a cellular phone.

Some embodiments of the invention relate to an apparatus for constructing and presenting a personalized web page, the personalized web page comprising one or more first modules, each first module is a fragment of a second web page having a locator, the fragment identified by at two or more coordinates within the second web page, wherein each coordinate comprises two numbers, the apparatus comprising: a storage device for storing the locator of the second web page and the coordinates; and a server platform, the server platform comprises a network importing component for selecting and submitting the locator of the second web page and the coordinates of the fragment of the second web page to the personalized web page; and a module addition component for adding the first modules to the personalized web page. The server platform can further comprise a component for enabling drag and drop operations. The server platform can further comprise a component for handling operations related to one or more users of the apparatus. Within the apparatus, the locator of the second web page can be a Unified Source Locator.

Embodiments of the present invention relate to a computer readable storage medium containing a set of instructions for a general purpose computer, the set of instructions comprising: a selection component for selecting a fragment of a first web page; a placement component for placing the fragment of the first web page on a personalized web page; and a storage component for storing a description of the personalized web page on a server.

In embodiments of the invention, a method for constructing and using a personalized electronic document on a computerized platform is presented. The electronic document details are retrieved from a storage device associated with a network server. The personalized electronic document details include at least one locator of a content source.

In embodiments of the invention, the method includes the step of selecting a fragment of at least one content source, the fragment identified by at least two coordinates.

In embodiments of the invention, the method includes the step of recording the locator of the content source and respective coordinates of the selected fragment within the electronic document details.

In embodiments of the invention, the method includes the step of integrating at least one selected fragment of the content source within the electronic document structure for creating the personalized electronic document.

In embodiments of the invention, the personalized electronic document is a web page.

In embodiments of the invention, the content of each fragment within the personalized electronic document is synchronized with the original source content of the fragment.

In embodiments of the invention, the content of all fragments of the personalized electronic document is refreshed at predefined interval.

In embodiments of the invention, the method includes the step of publishing the personalized electronic document within a data communication network.

In embodiments of the invention, all steps are enabled by a toolbar.

In embodiments of the invention, all steps are enabled by an add-in module associated with the computerized platform operating system.

In embodiments of the invention, the content source is designed to have predefined areas, enabling the user to select at least one area as a fragment.

In embodiments of the invention, the content source includes a utility application.

In embodiments of the invention, the content source comprises a web page, an Office application, for example an Office application file; a document (such as a Word document); a spreadsheet (such as Excel or Access spreadsheets); and a presentation (such as a Powerpoint presentation).

In embodiments of the invention, the content source is a Rich Site Summary (RSS) feed.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a schematic illustration of a personalized portal constructed according to some embodiments of the invention;

FIG. 2 is a schematic block diagram of an environment in which the disclosed invention is used, according to some embodiments of the invention;

FIG. 3 is a schematic illustration of the option to choose a predefined Rich Site Summary (RSS) feed component to be added to the personalized portal, according to some embodiments of the invention;

FIG. 4 is a schematic illustration of the option to choose a predefined utility to be added to the personalized portal, according to some embodiments of the invention;

FIG. 5 schematically shows a selected rectangle of a web page, according to some embodiments of the invention;

FIG. 6 schematically shows a personalized portal comprising the rectangle of FIG. 5, according to some embodiments of the invention;

FIG. 7 schematically shows an icon tray comprising miniaturized components, according to some embodiments of the invention;

FIG. 8 schematically shows an active desktop generated from the personalized web page, according to some embodiments of the invention;

FIG. 9 is a flow chart of the method for constructing and viewing a personalized web page, according to some embodiments of the invention;

FIG. 10 schematically shows a block diagram of system, according to an embodiment of the invention;

FIG. 11 is a flow chart of a method for constructing a personalized electronic document in accordance with some embodiments of the present invention; and

FIG. 12 is a flow chart of the method for presenting the personalized electronic document in accordance with some embodiments of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

For a better understanding of the invention, the usages of the following terms in the present disclosure are defined in a non-limiting manner: The term “Site shot” as used herein in this application, is defined as presenting a fraction of a web page within a page constructed in accordance with the disclosed invention; the term “RSS—Rich Site Summary” as used herein in this application, is defined as an Extensible Markup Language (XML)-based format, using a Source Description Framework (RDF) that allows the syndication of lists of hyperlinks, along with other information, or metadata. RSS allows a person's browser to fetch and understand the information, so that all of the lists that person is interested in can be tracked and personalized for them, subject to certain conditions such as mentioning the source of the information.

The present invention overcomes the disadvantages in the art by providing a novel method and a system which enables a user to build his/her personalized electronic document such as, e.g., a web page, and use it as a personal portal. The personalized electronic document is designed according to the user's preferences, and can contain various types of modules or components, and information from multiple sources. The modules can be, but are not limited to one or more fragments of any web page, RSS feeds, utilities, or other components. For example, a user can construct a personal portal comprising the top story from the web site of his favorite sports team, which can usually be found on the top left corner of the team's home page, news feeds from his favorite news site, a weather forecast, a sticker-like utility which is an editable textual memo, a calendar, a calculator or the like. The description of a specific user's web page is stored on a server and is associated with the user's name, so that the user can access his page from multiple computers. However, no content from other web pages is stored on the server implementing the disclosed invention. Once the user loads the web page to his browser, the browser accesses the web sites directly to get the information. In the case of RSS feeds, the browser accesses directly the relevant web site providing the feeds. Only the address of the page and the coordinates of the fragment selected by the user are stored on the server. In the case of rectangular fragments of a web page, the coordinates comprise two coordinates, denoting any two opposite corners of the rectangle, wherein each coordinate comprises two numbers, denoting the horizontal and vertical dimensions of the coordinate. When loading such a page, the whole page is loaded and clipped according to the desired coordinates. Additionally or alternatively, only the relevant fragment of the web page is loaded by the server implementing the disclosed invention. The user can design the personal portal freely or along grid lines, and can also minimize or edit one or more items. The one or more items can also be minimized into a tray icon which is always accessible. The system enables any combination of languages, both for the presented modules and components, and for the interfaces used by a user of the invention.

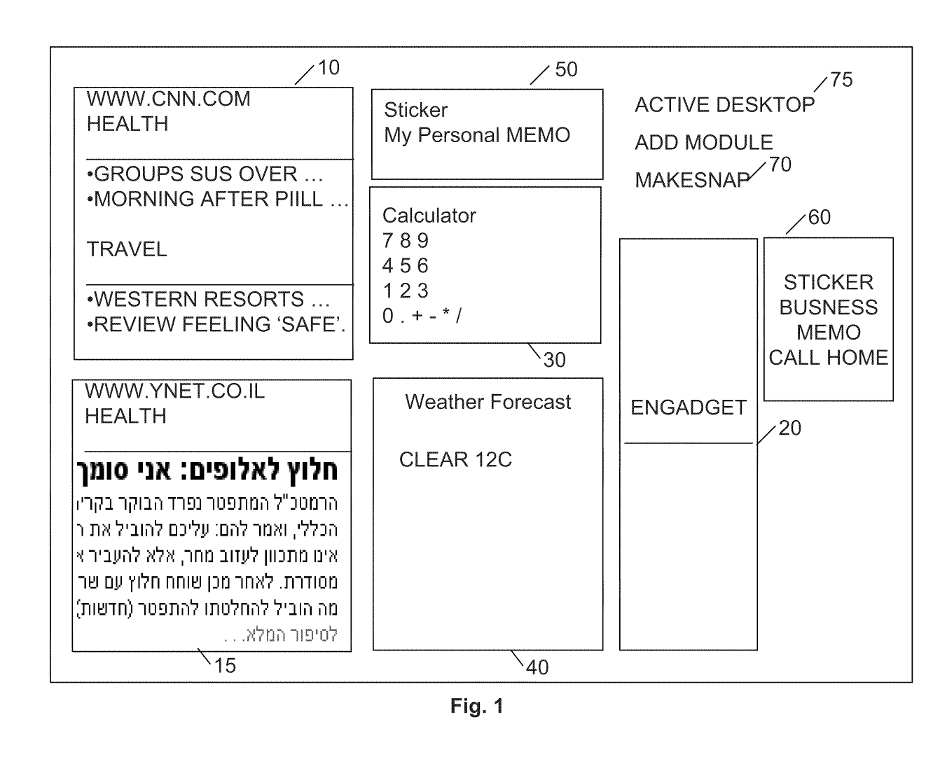

Reference is now made to FIG. 1, which schematically shows a personalized web page, according to some embodiments of the invention, comprising a part 10 from a web page in a first language, a part 15 from a web page in a second language, a news feed (RSS) from another page 20, a calculator 30, a whether forecast 40, and two memos: a personal one 50, and a business one 60. In accordance with an embodiment, each component of the page is editable, according to relevant parameters. For example, RSS feed 20 can be configured to show any number of news items, whether component 40 can be configured to show the weather in a certain city and for a certain number of days, and the like. Since the personalized page uses Unicode encoding for text, the page can simultaneously comprise items in multiple languages. For example, the page schematically shown in FIG. 1 comprises content in a first language, English, in most items, and content in a second language in item 60. Each item on the page can be collapsed, expanded, or sent to the icon tray. The personalized web page further comprises “makesnap” button 70. Adding the code associated with this button to the list of favorite addresses (for example, by right-clicking the button and choosing the option of “Add to Favorites”) enables the user to later capture fragments of other web pages and paste them into the personalized web page. The personalized web page also comprises an active desktop button 75. Pressing button 75 causes the modules currently residing on the personalized web page to be placed on the desktop of the user.

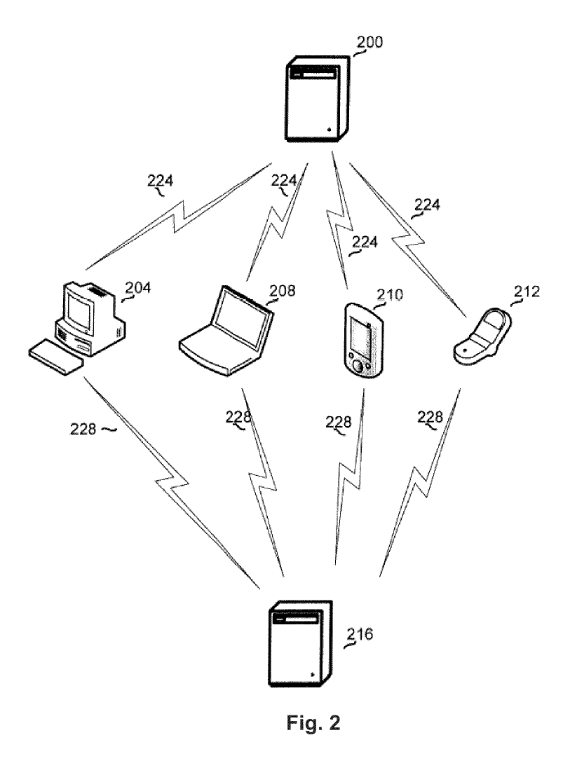

Reference is now made to FIG. 2, schematically showing an environment of the disclosed invention according to some embodiments of the invention. The core of the system is server 200, which is a computing platform, such as a personal computer, a mainframe computer, or any other type of computing platform that is provisioned with a memory device (not shown), a central processing unit (CPU) or microprocessor device, and several I/O ports (not shown). Additionally or alternatively, server 200 can be a (Digital Signal Processing) DSP chip, an Application Specific Integrated Circuit (ASIC) device storing the commands and data necessary to execute the methods of the present invention, or the like. Server 200 further comprises, or connects to one or more storage devices (not shown), storing the relevant applications, which are sets of logically inter-related computer programs and associated data structures. The storage is further used to store the descriptions of the pages constructed by the users of the system. Each storage device can be a magnetic tape, a magnetic disc, an optical disc, a laser disc, a mass-storage device, or the like. The users use the systems via one or more clients, which are also computing platforms. The client platform may be a personal or network computer 204, a laptop computer 208, a handheld device, such as a palm 210, a cellular phone 212, or any other platform provisioned with communication and computerized capabilities. The apparatus further comprises multiple web servers 216 hosting web pages, including portals or other sites. The user, using a personal computer 204, a laptop computer 208, a handheld device 210, or a cellular phone 212 communicates 224 with server 200 of the apparatus, which supports the building, storing and retrieval the personalized web page of the user. The user also communicates 228 with the various web sites from which he or she wishes to present information. As schematically shown in FIG. 2, server 200 does not communicate with content servers 216, and does not store content taken from servers 216. It stores merely links to these sites and optionally the coordinates associated with web pages stored on these servers. Communication means 224 and 228 can use any currently known communication protocols, such as hypertext transfer protocol (http), file transfer protocol (FTP), or other protocols currently known or that will become known in the future. The user's devices are not limited to the presented personal computer 204, a laptop computer 208, a handheld device 210, or a cellular phone 212, but can also be any other device currently known or that will be available in the future.

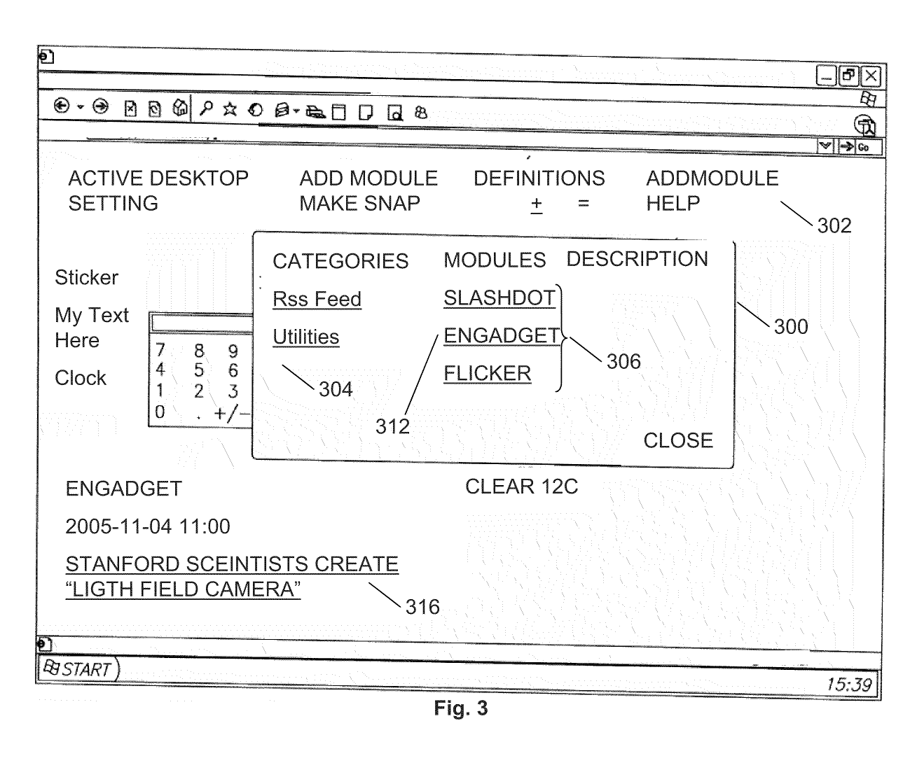

Reference is now made to FIG. 3, which schematically shows the option to add one or more RSS feeds to the personalized web page, according to some embodiments of the invention. Many sites, such as portals, supply one or more RSS feeds. RSS stands for Rich Site Summary, and using RSS enables the importation of data items in format of headlines to a web page, possibly under some terms, such as mentioning the site's name or the like. In FIG. 3, window 300 was opened when the user clicked on add module button 302. Window 300 enables the addition of, inter alia, RSS feeds or utilities to the personalized web page to be constructed. The user clicked on “RSS Feeds” button 304, and received the list of available RSS feeds 306 on the right hand side of the window. The list includes the RSS feeds suggested by the server of the disclosed apparatus, including, for example ENQADGET 312 which was already brought into the web page and can be seen on RSS pane 316 on the lower left corner of the web page. Once the user closes window 300, he or she can click on the edit button of pane 316 (not seen), and change the configuration, including for example, the presented number of items. The RSS feeds are converted by the disclosed apparatus from the format supplied by the RSS source, into the format used by the browser.

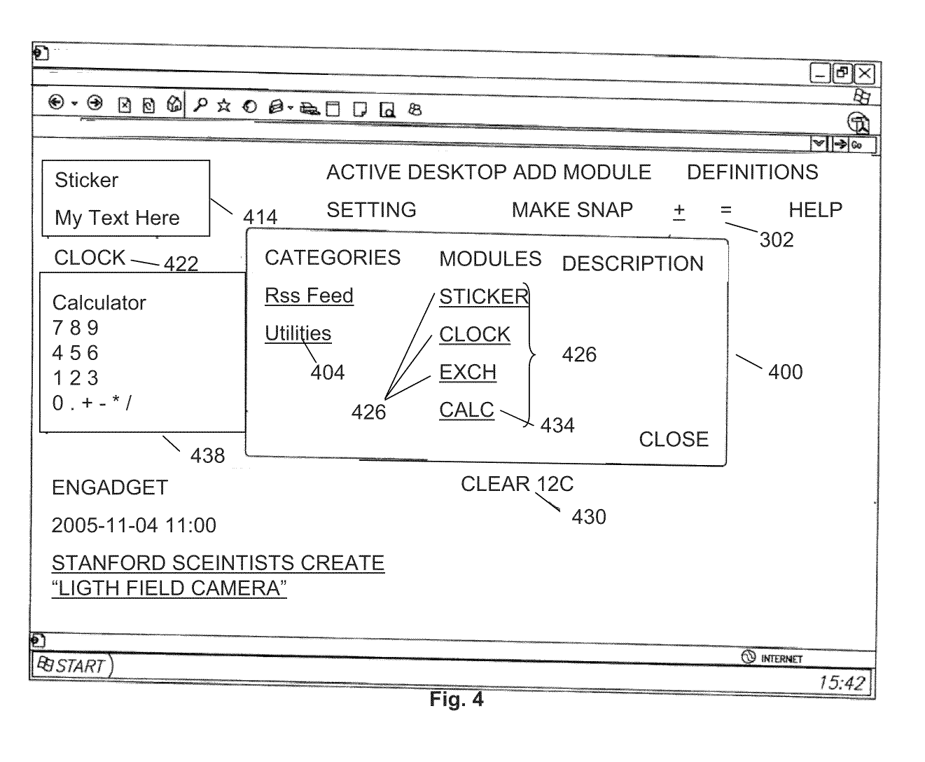

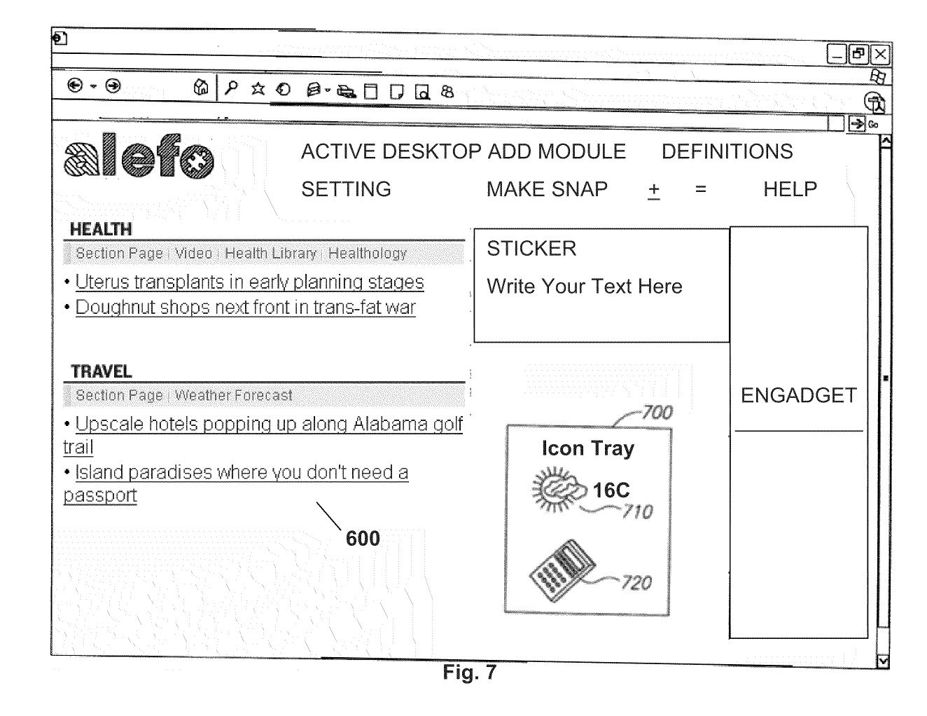

Reference is now made to FIG. 4, which schematically shows the addition of one or more utilities to the personalized web page, according to some embodiments of the invention. In FIG. 4, window 400, which appears when the user clicks on Add Module button 302, enables the addition of one or more utilities to the web page. The user clicked on “Utilities” button 404, and received the list of available utilities 406 on the right hand side of the window. The list includes the utilities suggested by the server of the disclosed apparatus, including, for example sticker 410 which can be seen in pane 414, clock 418 which is collapsed pane 422, weather utility 426 seen in pane 430 and calculator utility 434 shown in pane 438. Adding a utility to the web page runs the code implementing that utility on the server to the web page, so that when the page is displayed, the code is activated, and the utility is presented and functioning. The user can move, resize, collapse, or expand any utility. The user can further change the utility according to relevant options, for example show a calculator in a normal or in a scientific configuration. The user can further move any utility to the icon tray, detailed in association with FIG. 7 below.

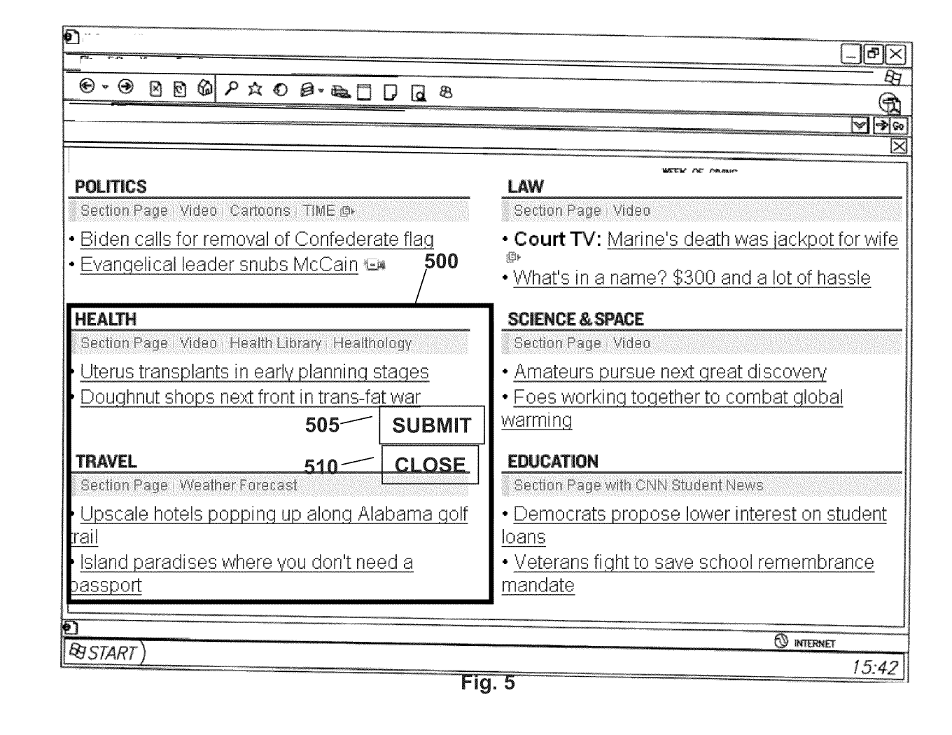

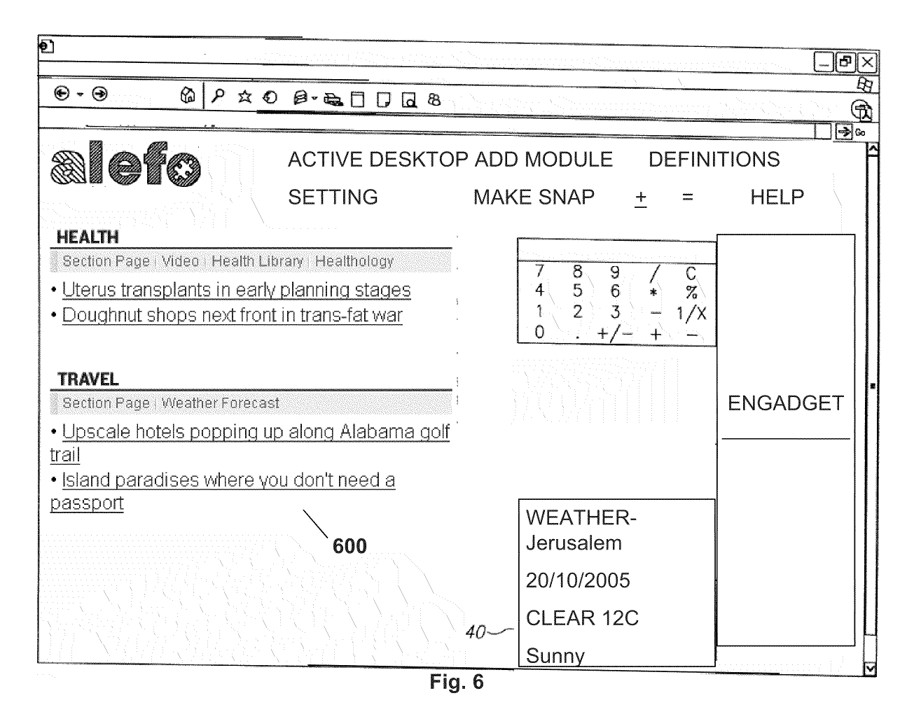

Reference is now made to FIGS. 5 and 6, which schematically show the option of adding a site shot, i.e. a fragment of a web page to a personalized web page, according to some embodiments of the invention.

FIG. 5 schematically shows a regular web page, a part of which the user wishes to bring to his or her personalized web page, according to some embodiments of the invention. Once he desired page is presented, the user activates the “site shot” option, by running, for example, a code fragment which was earlier stored in the “favorites” of the browser. Then the user is allowed to choose an area of the screen by, for example, a substantially rectangular window, as schematically indicated with area 500 in FIG. 5. In an embodiment of the invention, the area is selected by clicking down the left mouse button on the top left corner of the desired area, dragging the mouse to the bottom right corner and then releasing the left mouse button. Once the button is released, the user can resize, move or otherwise change the selected rectangle. Once the button is released, the option to insert the selected part of the page is enabled. In an embodiment of the invention, a “submit” button 505 appears, which when clicked adds the relevant area to the personalized web page. When the user clicks “close” button 510, the selection is de-selected and buttons 505 and 510 disappear.

According to an additional embodiment of the present invention the user can install a dedicated toolbar. The user downloads and installs the dedicated toolbar in accordance with browser toolbar technology as is known to people who are skilled in the art. The dedicated toolbar enables the user to select web pages segments and submit the selected area from the desired web page. The dedicated toolbar includes operational buttons including, but not limited to, “site shot”, select, submit and close buttons. The user can browse through different web pages. When encountering a web page he or she wishes to have segments of which in their personalized page the user can use the toolbar to select the desired segments. The user presses on the “site shot” button on the dedicated toolbar to activate the site segment selection procedure. After pressing on the “site shot” button the user selects the desired area by clicking down the left mouse button on the top left corner of the desired area, dragging the mouse to the bottom right corner and then releasing the left mouse button. Once the button is released, the user can resize, move or otherwise change the size of the selected rectangle. Once the button is released, the option to insert the selected part of the page in the toolbar is enabled. The “submit” and “close” buttons in the toolbar are enabled and the user may add the selected area to the personalized web page by selecting the “submit” button or cancel the operation by clicking on the “close” button. According to other embodiments of the present invention the dedicated toolbar is installed on the operating system level and may be activated independently of the web browser. Thus, provided that the user uses more than one browsing means to enter web pages, such as opening web pages on a RSS reader or on an email application, the dedicated toolbar can be activated in all of these applications. According to an additional embodiment of the present invention the functionality described above may be integrated into an existing toolbar. In this case the operational buttons can be added to the toolbar and installed with it.

According to some embodiments of the present invention web pages builders can define segments of their pages as appropriate for selection by users to put on their personal web pages. For instance, builders of news web pages may mark the headlines or the weather forecast sections as potentially interesting for users to put on their personal web pages. According to these embodiments when the user activates the “site shot” option, the areas which the web page builder predefined as appropriate for selection are visually marked. For instance, the relevant sections may appear surrounded by a frame. To select the predefined areas the user needs only to turn on the “site shot” option, click on the selected area he or she wants to transfer to the personal web page and click the “submit” option. However, the user may ignore the selections provided by the web page builder and select other segments of the web page according to the methods described above.

FIG. 6 schematically presents the personalized web page, including the relevant part of the page as schematically shown in FIG. 5, in pane 600. Server 200 of FIG. 2, which stores or connects to a storage of the personalized web pages stores merely a locator, such as the Uniform Source Locator (URL) of the web page, and the coordinates of the area selected by the user. Any other currently known web page locator, or a locator that will become known later can be used for storage. The coordinates of the selected fragment within the page can be, for example, the coordinates of the top left and the bottom right points of the fragment. The content of the web page itself are not loaded to the server of the disclosed invention (server 200 of FIG. 2), but is loaded by the browser during page loading and when refreshed. The personalized web page may be programmed to refresh its content at every predetermined time interval or simply refreshed manually by the user. Additionally, provided that selected web pages have preprogrammed refresh rates their content is also refreshed in accordance with their refresh rate. Then the browser clips the contents of the page according to the stored coordinates, and presents just the clipped area. As can be seen from comparing FIG. 5 and FIG. 6, the coordinates of part 500 within the web page schematically shown in FIG. 5 are not related to the coordinates of part 600 within the personalized web page schematically shown in FIG. 6. In an embodiment of the disclosed invention, the code which implements the addition of the page part to the personalized web page is:

javascript:uid=‘1’;
(function( )
{
s=document.createElement(‘script’);
s.type=‘text/javascript’;
s.id=‘_alefo_script’;
s.src=‘http://www.alefo.com/modules/siteshot/siteshot.js.php?uid=’+uid;
document.body.appendChild(s);
})( );

Other codes may be used.

In an embodiment of the invention, the server screens the web page chosen by the user, excluding the area selected by the user, so that only that area is shown on the personalized web page.

Persons skilled in the art will appreciate that other implementations of the submission exist, and further ones might exist in the future.

Reference is now made to FIG. 7, which schematically shows the usage of Icon Tray 700, according to some embodiments of the invention. In FIG. 7, icon tray 700 comprises weather tool 710 and calculator 720, which were earlier dragged into the icon tray. When an object, such as a utility resides in the icon tray, it does attempt to show some details, for example the current temperature associated with the settings of the weather tool. Any RSS feed, utility, part of page, or another element can be dragged into or out of the icon tray. The icon tray can be moved around and placed anywhere on the personalized web page.

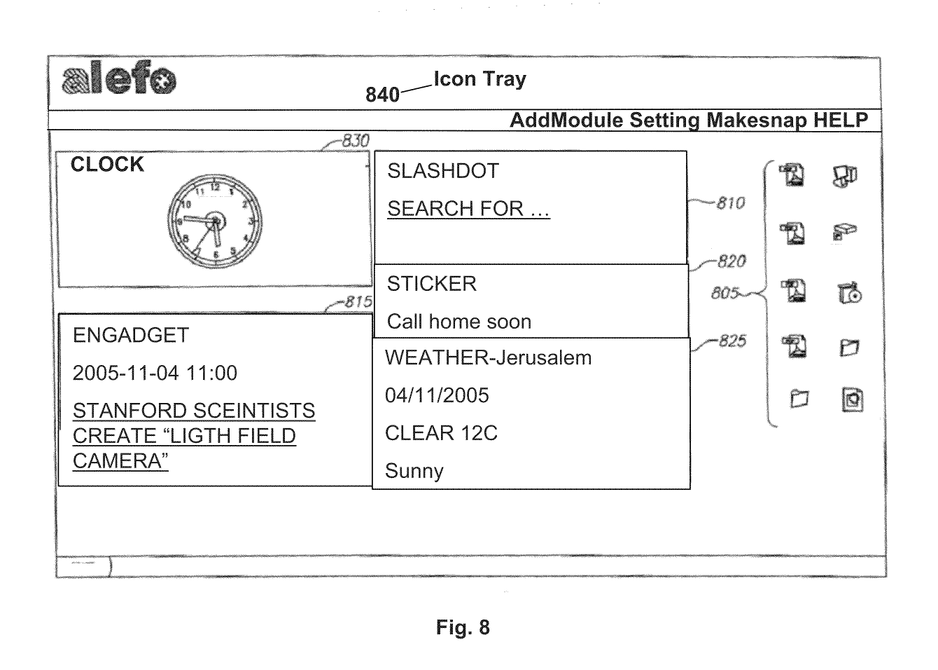

Reference is now made to FIG. 8, which schematically shows an active desktop of a user's computer, generated by pressing the active desktop button 75 of FIG. 1, according to some embodiments of the invention. Please note that FIG. 8 was generated from a different personalized web page than the one schematically shown in FIG. 1, and therefore contains different modules. In addition to icons 805 which are an ordinary part of a desktop of a personal or a network computer, the active desktop schematically shown in FIG. 8 comprises RSS feeds 810 and 815, memo note 820, whether forecast 825 and clock 830. Any of these items is functional, and can be resized, moved, collapsed, put on icon tray 840 on the desktop, or otherwise manipulated in the same manner as on the personalized web page.

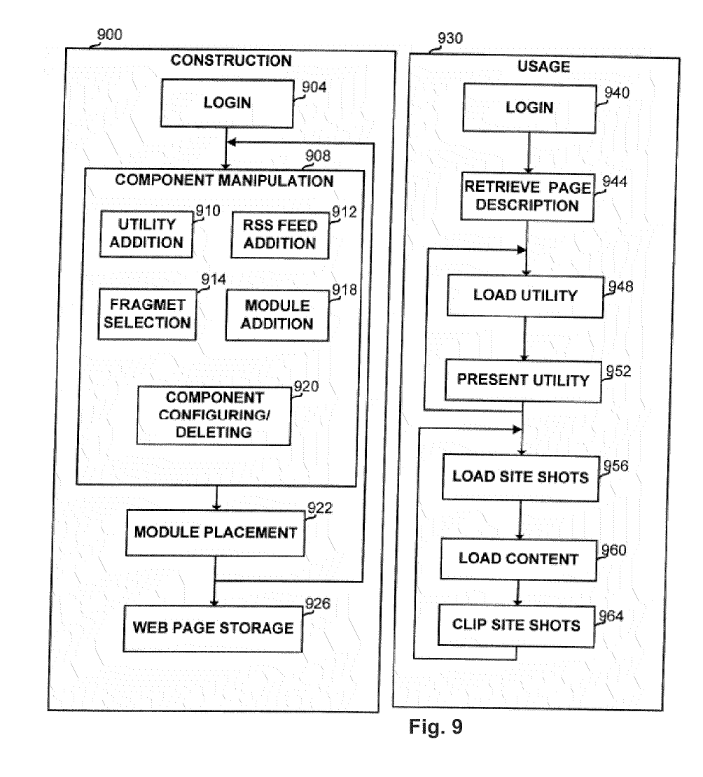

Referring now to FIG. 9, which schematically shows the main steps associated with the method according to some embodiments of the invention. At step 900 the page is constructed, and at step 930 it is used. Construction step 900 includes login to the system at step 904, in which the user identifies to the system and is requested to supply a password. The system stores session variables in a persistent cookie, so when the user reloads the personalized page after the session has expired, the session variables are reloaded from the cookie, as if the navigating is continued in the site in the same session. The internet protocol (IP) address of the computer the user is using is not referred to, so that a person can access the same personalized page from multiple computing platforms, including his or her cellular phone, handheld device, laptop computer or the like. In addition, the user can logout and login under a different name, for example when the same platform is used by multiple users. Then, at step 908, the user manipulates the modules he or she wishes to have on the web page. The manipulation can include adding a utility at step 910, as was discussed in association with FIG. 3 above, or component configuring or deleting at step 920. The utilities can include a clock; a world clock; a calendar; a holiday and special times utility; a chat tool for chatting with other users of the disclosed invention; a radio-like or TV-like tool; a media guide; a bills payment service; a postal delivery service; a price comparing tool; a phone directory; an SMS or MMS sending tool; a translator or a trans-literature tool; a downloading tool; a weather reporting tool; a calculator of any type, including a scientific calculator, an economics calculator and others; an e-mail checking utility; a maps utility; a currency exchange and conversion rates tool; a memo pad; a search engine; a domain-specific utility; such as a stock quote tool, or any other utility. The Utilities may further comprise an Office application file; a document (such as a Word document); a spreadsheet (such as Excel or Access spreadsheets); and a presentation (such as a Powerpoint presentation). The utilities can be supplied by a server of the disclosed invention, or can be implemented and used by any user. At step 912 the user can add an RSS feed component. The source of the RSS feed can be chosen from the RSS feeds suggested by the server, or from any site offering the RSS service. At step 914 the user selects one or more fragments of one or more web pages, i.e. site shots, to be added to the personalized web page. The site shot is a rectangular fragment of a specific web page. For that end, the user loads the web page, activates a component that first enables the selection of rectangle, the resize or moving of the rectangle, and then provides a “submit” option. When the user selects the “submit” option, the address of the web page and the coordinates of the rectangle chosen by the user are submitted to the server of the disclosed invention and stored there. It is important to note that no content from the web page is transmitted to or stored by the server, but only the address and the coordinates of the required fragment within the web page, which are not to be confused with the coordinates in which the fragment is placed within the personalized web page. The loading of the content is explained at step 960 below. At step 918 additional types of modules, currently known or that will become known in the future are added to the web page. At step 920 any component is configured according to its type, or removed from the page. At step 922, the user can manipulate the modules on the page, resize, move, miniaturize, enlarge, add to the icon tray or retrieve from the icon tray any component of the page. Additionally or alternatively, the system can place the modules on the web page, and the user can then change the placement according to his or her preferences. The system updates the server after every change to the page, but can alternatively update the server only when the user explicitly asks to do so. The user can use an option to snap the objects to a grid, or can place them freely over the page at any desired layout. The server optionally parses the elements and their locations, thus constructing and saving it in any adequate format, such as XML, Hypertext Markup Language (HTML) or any other. At step 926, the description of the web page is stored on the storage device associated with server 200 of FIG. 2. Additionally or alternatively, the storage step takes place after each change to the personalized web page, i.e. after each addition, deletion, change, or the like. At step 930, the user uses, i.e., loads the personalized web page he or she constructed at step 900. This step optionally involves logging into the system at step 940, similarly to step 904 above, and then loading the description of the stored web page at step 944. As mentioned above, the page is stored at the server in HTML, XML or any another format. Once the page is loaded, each element is loaded according to its type. At step 948 each utility is loaded from the server, or from any other location it is stored at. At step 952, the utility is presented, taking into account its settings. For example, a calculator can be presented as simple or as scientific. Steps 948 and 952 are performed for all utilities on the personalized web page. At step 956, one site shot is loaded, i.e., the link and the coordinates are received from the server. Then, the browser accesses directly the web site associated with the site shot, loads the contents of the web page at step 960, and clips the web page so that only the part of the page which is bounded by the coordinates at step 964 is presented. Steps 956, 960, and 964 are performed for all site shots of the web page. It would be clear to a person skilled in the art that the relative order, in which the utilities and the site shots are presented, is set by the browser. In an alternative embodiment, the order can be set by an apparatus implementing the disclosed invention.

In an alternative embodiment the presented steps can also be implemented in a different manner. For instance, the web page elements can be loaded one at a time according to the order in which they are supplied by the server, and not necessarily a sequence of all the utilities and then a sequence of all the site shots. The steps presented above or their order is not mandatory. A person skilled in the art would appreciate that an implementer of the invention can divide the basic operations of adding, changing, or deleting page elements into different steps, and a user of the invention can use them in arbitrary order.

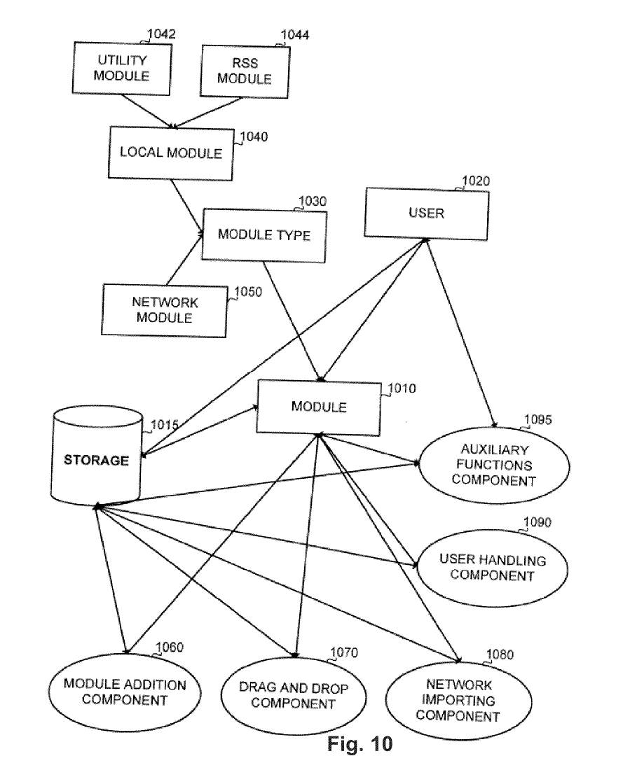

Reference is now made to FIG. 10, which schematically shows a block diagram of system, according to some embodiment of the invention.

This apparatus is implemented by a computerized system, which enables, for example, object oriented environments, such as C++, C#, Java or any other type of environments. In an embodiment of the invention, the basic unit is a module object 1010, which represents one object placed on a personalized web page of a specific user. In an alternative embodiment, module object 1010 can also represent a collection of objects placed on one or more personalized web pages. Each module object 1010 contains information relevant for the presentation of the object on the screen, including its title, its editing options, comprises information relevant for the placement of the module on the web page, such as the location, whether the module is expanded or collapsed, and the like. Each module object 1010 either contains, points at, or is otherwise related to a user object 1020. User object 1020 contains the identification, preferences, templates and other information related to the user. User object 1020 comprises a collection, such as an array, of the module objects contained on the user's personalized page. Module object 1010 further points at, derives from, or contains module type object 1030, which represents the type of the relevant module, and contains relevant information. Module type object 1030 can derive, inherit or otherwise relate to a local module type 1040, a network module type 1050, or another type. Local module type 1040 can be related to a utility module 1042, such as a calculator, a weather reporting module, a calendar, a search engine, a memo, or any other utility implemented as part of the apparatus. In the case of a utility module, object module 1010 will contain relevant information, such as the contents of the memo, the city for which the whether is reported, or the like. Local module type 1040 can also be related to RSS module type 1044. In this case, object module 1030 contains the address of the RSS source, the number of requested items, and the like. Additionally or alternatively, module type 1030 derives or inherits from a network module 1050. Network module 1050 relates to a component which includes a fragment of the web page that is placed on the personalized web page, such as component 10 of FIG. 1. Network module 1050 comprises or otherwise has access to the locator, such as the URL of the relevant web page, and the coordinates of the selected fragment within the web page. The content of the web page itself is not a part of the system, and is loaded by the browser of the user directly from the web page. All the information about users 1020 and modules 1010 is stored in storage 1015. Storage 1015 is further detailed in association with server 200 of FIG. 2. The system further comprises components that implement the methods of the disclosed invention. The components can be implemented as stand-alone, web services, part of an object, part of an object-type, or in any other technique currently known or that will become known in the future. The components include module addition component 1060, which is responsible for enabling the user to choose a component from a predefined list, such as the utility modules, from an RSS feed suggested by the system or from any other source. Drag and drop component 1070 comprises the routines used when modules are moved around the personalized web page through dragging and dropping, dragged to or from the icon tray or the like. Network importing component 1080 is responsible for enabling the selection and submission of a fragment of a web page to the personalized web page, as detailed in association with FIGS. 5 and 6 above. User handling component 1090 comprises routines for adding, deleting, updating or otherwise handling the operations related to users of the system. Auxiliary functions component 1095 comprises general routines, such as database access and handling routines, security, and the like. Auxiliary functions component 1095 can further comprise routines or other code fragments for optimal placement of the components on the personalized web page, with or without horizontal or vertical grid lines. The routines supplied by Auxiliary functions component 1095 can be used by any component of the system, including but not limited to module addition component 1060, drag and drop component 1070 and network importing component 1080. All routines which belong to components 1060, 1070, 1080, 1090 and 1095 communicate with the relevant module objects 1010 and with storage 1015, so that the personalized web page, with the updated information relating the modules is stored after each operation of the user, and will therefore be loaded in the same configuration the next time the user accesses it, either from the same platform or from a different one. In an embodiment of the invention, the abovementioned objects are constructed and the components run on server 200 of FIG. 2, and accessed by any client, such as 204, 208, 210, or 212 of FIG. 2.

It will be appreciated by a person skilled in the art that this division to objects and implementation components is not mandatory, and many systems, such as C# provide the option, or even compel the implementer to implement a function within an object. The various data members and functionalities can be distributed in other manners between components of the system. For example, auxiliary routines can be implemented as parts of certain objects or other components, and not necessarily as an independent unit.

It will also be appreciated by a person skilled in the art that additional entities and operations have to be imported into the system or implemented as part of the apparatus, such as database handling, network communication, graphics, backup, security, or the like. However, such components are known in the art and implemented as a part of almost any network apparatus. Therefore they were omitted from the above description for clarity reasons.

The presented methods and apparatus enable a user to construct and use a personalized web page, comprising all the information he or she needs, including utilities, RSS feeds, flash objects, relevant fragments of various web pages and others. The personalized web page can be accessed from multiple computing platforms, including cellular phones or handheld devices that enable surfing the internet, laptops and other platforms. However, each one of multiple users using the same computing platform will have his or her own personalized web page, constructed according to their own preferences and requirements. The personalized web page can comprise information in multiple languages, and update in predetermined refresh rates. The web page can be further transformed to be an active desktop of a user. Additionally or alternatively, the personalized web page may be published and made available on the web as a website for others to access and see. The process of publishing the web page and making it accessible for users of the web is performed in accordance with prior art as it is known to people who are skilled in the art.

Also within the scope of the present invention is an embodiment which enables including sections of documents in a personalized web page. The processes of incorporating the selected sections of the documents on the web page are similar to the methods described above. However, when a segment of an electronic document is selected by the user to be included in his or her web page the server stores all the information which is in the selected segment of the document. When the user loads the personalized web page the server retrieves the stored information and this information is displayed on the personalized web page according to the user preferences.

According to additional embodiments of the present invention the segments of the selected web pages may be incorporated into any type of document which the user produces or edits. For instance, the segments of the web pages may be inserted into a personalized electronic document such as, e.g., a text processing document, a spreadsheet processing document or any other electronic document. Additionally or alternatively, embodiments of the present invention enable creating a personalized toolbar, i.e., the user may select segments of the web page and add them to a toolbar for personalization.

The following is a description of one possible implementation of the described embodiments. In order to activate the implementation of these embodiments the user installs a small executable add-in. The add-in enables inserting and refreshing the data of the segments of the web pages in the edited personalized electronic document. The add-in uploads the selected segment of the web page into the document when the user opens the documents and whenever the refresh command is given. The refresh command may be given by the user manually and the add-in executable may be programmed to automatically activate the refresh command at predefined intervals. According to some embodiments provided that the original web page includes a predetermined refresh rate the add-in executable can be programmed to identify this refresh rate and automatically activate the refresh command according to this rate.

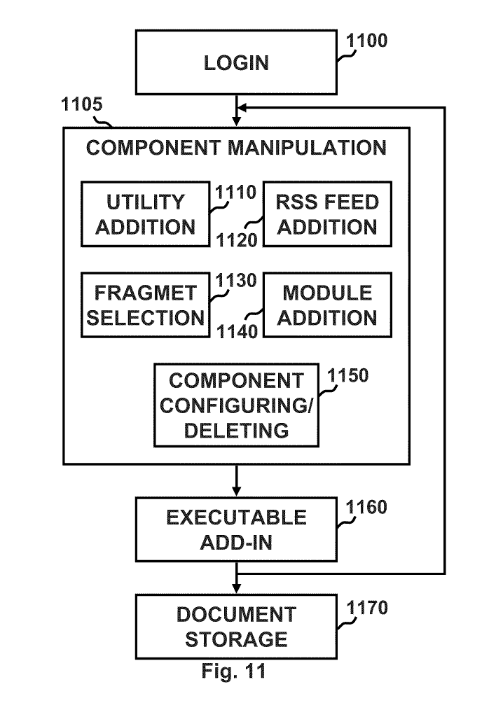

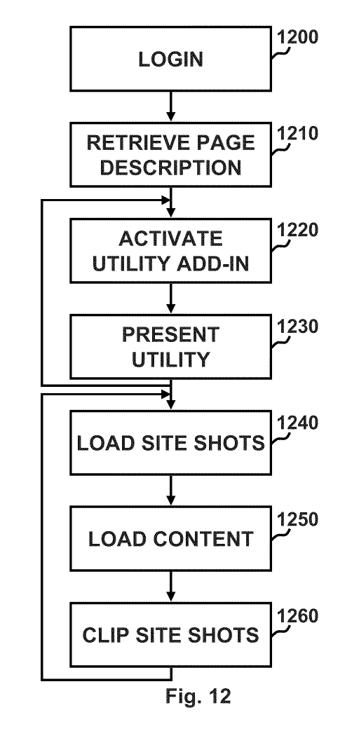

Referring now to FIG. 11, which schematically shows the main steps associated with the construction according to some embodiments of the invention. The construction of the page includes login to the system at step 1100, in which the user identifies to the system by supplying a string that corresponds to a password, for example. The system stores session variables in a persistent cookie, so when the user reloads the document after the session has expired, the session variables are reloaded from the cookie, as if the navigation is continued in the site in the same session. Then, at step 1105, the user manipulates the modules he or she wishes to have on the document. The manipulation can include adding a utility at step 1110, as was discussed above, or component configuring or deleting at step 1150. The utility can be any one of the above mentioned utilities. The utilities can be supplied by a server of the disclosed invention, or can be implemented and used by any user. At step 1120 the user can add an RSS feed component. The source of the RSS feed can be chosen from the RSS feeds suggested by the server, or from any site offering RSS services. At step 1130 the user selects one or more fragments of one or more web pages, i.e. site shots, to be added to the document. A site shot is a rectangular fragment of a specific web page. For that end, the user loads the web page, activates a component that first enables the selection of a rectangle, the resize or moving of the rectangle, and then provides a “submit” option. When the user selects the “submit” option, the address of the web page and the coordinates of the rectangle chosen by the user are submitted to the server of the disclosed invention and stored there. It is important to note that no content from the web page is transmitted to or stored by the server, but only the address and the coordinates of the required fragment within the web page, which are not to be confused with the coordinates in which the fragment is placed within the document. The loading of the content is explained in FIG. 12 below. At step 1140 additional types of modules, currently known or that will become known in the future are added to the document. At step 1120 any component is configured according to its type, or removed from the document. At step 1160 the executable add-in is activated for the purpose of adding the selected components to the document. The user can manipulate the modules on the page, resize, move, miniaturize or enlarge any component using the built-in document object editing tools. The system updates the server following every change performed in the document, but can alternatively update the server only when the user explicitly asks to do so. At step 1170, the description of the document components are stored on the storage device associated with server 200 of FIG. 2. Additionally or alternatively, the storage step takes place after each significant change in the document, i.e. after each new component is added.

The process of using the previously constructed document is schematically illustrated in FIG. 12. This step optionally involves logging into the system at step 1200 and then loading the description of the stored document at step 1210. The body of the document is stored on the client platform, such as a personal computer, a laptop computer, a handheld device, or a cellular phone, which can support the production and editing of documents and which can communicate with a server. Once the document is loaded, each element is loaded according to its type. At step 1120 the executable add-in is activated and it retrieves each utility which is loaded from the server, or from any other location it is stored at. At step 1230, the utility is presented, taking into account its settings. For example, a calculator can be presented as simple or as scientific according to its settings as determined by the user. Steps 1220 and 1230 are performed for all utilities in the document. At step 1240, one site shot is loaded, i.e., the link and the coordinates are received from the server. Then, the add-in directly accesses the web site associated with the site shot, loads the content of the web page at step 1250, and clips the web page so that only the part of the page which is bounded by the coordinates at step 1260 is presented. Steps 1240, 1250, and 1260 are performed for all site shots of the document. It would be clear to a person skilled in the art that the order, in which the utilities and the site shots are presented, is set by the executable add-in. In an alternative embodiment, the order can be set by an apparatus implementing the disclosed invention. According to yet another embodiment, all utility and web site information may be stored on the client platform instead of on the server.

It is to be understood that some embodiments of the invention may be implemented, for example, using a machine-readable medium or article which may store an instruction or a set of instructions that, if executed by a machine, cause the machine to perform a method or operations or both in accordance with embodiments of the invention. Such a machine may include, for example, any suitable processing platform, computing platform, computing device, processing device, computing system, processing system, computer, processor, or the like, and may be implemented using any suitable combination of hardware or software or both. The machine-readable medium or article may include but is not limited to, any suitable type of memory unit, memory device, memory article, memory medium, storage article, storage device, storage medium or storage unit such as, for example, memory, removable or non-removable media, erasable or non-erasable media, writeable or re-writeable media, digital or analog media, optical disk, hard disk, floppy disk, Compact Disk Recordable (CD-R), Compact Disk Read Only Memory (CD-ROM), Compact Disk Rewriteable (CD-RW), magnetic media, various types of Digital Versatile Disks (DVDs), a tape, a cassette, or the like. The instructions may include any suitable type of code, for example, an executable code, a compiled code, a dynamic code, a static code, interpreted code, a source code or the like, and may be implemented using any suitable high-level, low-level, object-oriented, visual, compiled or interpreted programming language. Such a compiled or interpreted programming language may be, for example, C, C++, Java, Pascal, MATLAB, BASIC, Cobol, Fortran, assembly language, machine code and the like.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A computer implemented method of constructing a personalized web page, comprising:
storing a first web page on storage media coupled to at least one computer server;
serving the first web page to at least one client computing platform using the at least one computer server; and,
providing means operative with the first web page for:
enabling the selection of a visible area of a second web page by designating coordinates of a screen region of the visible area of the second web page wherein the selection is arranged to be performed as a single action by the user;
storing the address of the second web page and the coordinates of the visible area selected of the second web page;
loading the visible selected area of the second web page within the first web page based on the stored address of the second page and the coordinates of the selected visible area, such that the visible appearance of the visible selected area on the first web page has substantially the same visual appearance as the visible selected area on the second page; and,
reloading the selected area of the second web page within the first web page,
wherein the storing of the address of the second web page and the coordinates of the visible area selected and the loading of the visible selected area of the second web page within the first web page are performed automatically and responsive to the single action of the user selection of coordinates of the selected visible area.

2. The computer implemented method of claim 1, further comprising:
storing first information pertaining to clients of the at least one client computing platform, using the at least one server;
storing second information comprising the Uniform Resource Locator of the second web page, and the location of the selected area within the second web page, on the at least one server; and
associating the second stored information with the first stored information.

3. The computer implemented method of claim 1, wherein the enabling the selection of a visible area comprises selecting at least one area from at least one other web page.

4. The computer implemented method of claim 1, wherein the providing means operative with the first web page further comprises:
enabling the selection of a utility application within the first web page; and
loading the utility application within the first web page.

5. The computer implemented method of claim 4, wherein the utility application comprises at least one of: a clock; a world clock; a calendar; a holiday and special times utility; a chat tool; a radio tool; a TV tool; a media guide; a bills payment service; a postal delivery service; a price comparing tool; a phone directory; a Short Message Service (SMS) sending tool; a Multimedia Messaging Service (MMS) sending tool; a translator/trans-literature tool; a downloading tool; a weather reporting tool; a calculator; an e-mail utility; a maps utility; a currency exchange and conversion rates tool; a memo pad; a search engine; a stock quote tool; a domain-specific utility; an Office application file; a document; a spreadsheet; and a presentation.

6. The computer implemented method of claim 1, wherein the reloading the selected area is carried out when requested by the at least one client computing platform.

7. The computer implemented method of claim 1, wherein the reloading the selected area is carried out when the second web page is changed.

8. A system for constructing at least one personalized web page, comprising:
at least one server;
means operative with the server for serving a first web page to at least one client computing platform;
means operative with the first web page for:
enabling the selection of a visible area of a second web page by designating coordinates of a screen region of the visible area of the second web page wherein the selection is arranged to be performed as single action performed by the user;
storing the address of the second web page and the coordinates of the visible area selected of the second web page;
loading the visible selected area of the second web page within the first web page based on the stored address of the second page and the coordinates of the selected visible area, such that the visible appearance of the visible selected area on the first web page has substantially the same visual appearance as the visible selected area on the second page loading the visible selected area of the second web page within the first web page based on the stored address of the second page and the coordinates of the selected visible area performed automatically responsive of the single action of the user selection of coordinates of the selected visible area; and
reloading the selected area of the second web page within the first web page.

9. The system of claim 8, wherein the means operative with the first web page further comprise means for enabling drag and drop operations.

10. A method for constructing and using a personalized electronic document on computerized platform, wherein the electronic document details are retrieved from a storage device associated with a network server, wherein the electronic document details include at least one locator of a content source, the method comprising:
selecting at least one fragment of at least one content source, wherein each fragment is identified by at least two coordinates;
recording the locator of the content source and respective coordinates of the selected fragment within the electronic document details; and
integrating at least one selected fragment of the external content source within the electronic document structure.

11. The method of claim 10, wherein the personalized electronic document comprises at least one of: a web page; a text editing program; and a spreadsheet.

12. The method of claim 10, wherein the content of each fragment within the electronic document is synchronized with the original source content of the fragment.

13. The method of claim 10, wherein the content of all fragments of the personalized electronic document is refreshed at predefined interval.

14. The method of claim 10, further comprising publishing the electronic document within a data communication network.

15. The method of claim 10, wherein all steps are enabled by a toolbar.

16. The method of claim 10, wherein all steps are enabled by an add-in module associated with the computerized platform operating system.

17. The method of claim 10, wherein the content source is designed to have predefined areas, enabling the user to select at least one area as a fragment.

18. The method of claim 10, wherein the content source includes a utility application.

19. The method of claim 10, wherein the content source is a RSS feed.

20. The method of claim 10, wherein the content source comprises at least one of: a web page, an Office application.
